(19) United States
(12) Patent Application Publication
(10) Pub. No.: US 2011/0221871 A1
(43) Pub. Date: Sep. 15, 2011

(54) DISPLAY DEVICE AND AUDIOVISUAL DEVICE

(76) Inventors: Hidenori SAKANIWA, Yokohama (JP); Takashi KANEMARU, Yokohama (JP); Sadao TSURUGA, Yokohama (JP)

(21) Appl. No.: 12/908,396

(22) Filed: Oct. 20, 2010

(30) Foreign Application Priority Data
Mar. 12, 2010 (JP) JP 2010-055285

(51) Int. Cl. H04N 13/04

(52) U.S. Cl. 348/51; 348/E13.026

(57) ABSTRACT

The display device is configured to comprise an input part into which video image information is input and a display part displaying the video image information input into the input part and, if the displayed video images are switched from 3D video images to 2D video images, is devised to modify the brightness of the displayed video images over a prescribed period of time.

### INCORPORATION BY REFERENCE

The present application claims priority from Japanese application JP2010-055285 filed on Mar. 12, 2010, the content of which is hereby incorporated by reference into this application.

### BACKGROUND OF THE INVENTION

The technical field is related to a display device displaying video images.

In JP-A-1995-336729, it is disclosed that: the fact that “only dark images are visible because the amount of light entering one eye is equal to or less than half the actual amount of light of the image since spectacles, or a polarizing plate, having a light obscuring means such as a liquid crystal shutter originally have low transmittance” (refer to Paragraph 0007 of JP-A-1995-336729); the fact that “since one side of the field of the display screen is watched with only one eye, the result is that the resolution is halved, and consequently only an image with blurred contours is visible” (refer to Paragraph 0008 of JP-A-1995-336729); and the fact that “since a display screen with a one-side field is only watched with one eye, only screens with a lot of flicker can be seen, making it very difficult to watch” (refer to Paragraph 0009 of JP-A-1995-336729) are regarded as problems requiring resolution; and, as a solving means therefor, “there is provided, an image display device consisting in having: a main display means alternately displaying an odd field and an even field with a prescribed period on a display screen on the basis of interlaced video image signals input from a video image signal originating source; an auxiliary display means disposed between an observer observing a screen of the concerned main display means and the concerned screen and modifying a visual confirmation image for the concerned observer; and a control means modifying the display state of at least one of the concerned main display means and the concerned auxiliary display means in response to the type of the concerned interlaced video image signal; wherein the concerned control means has: a three-dimensional image signal detection means detecting whether or not the concerned video image signal is a three-dimensional image signal; and a display control means modifying, in response to the detection result of the concerned three-dimensional image detection means, the display state of at least one of the concerned main display means and the concerned auxiliary display means; and wherein the concerned three-dimensional image signal detection means has a correlation evaluation means obtaining the correlation between the odd field and the even field of the concerned video image signal; and being capable, by modifying the display state of at least one of the concerned main display device and the concerned auxiliary display device in response to whether or not the concerned video image signal is a three-dimensional image signal, of distinctly carrying out the observation of a three-dimensional image and the observation of a plane image, respectively” (refer to Paragraph 0014 of JP-A-1995-336729).

Also, in JP-A-2006-228723, the fact that “there has come to be demanded a backlight module, and a display device using the same backlight module, that does not give rise to a marked reduction in brightness even when switching from a 2D image display mode to a 3D image display mode of a 2D/3D display device is carried out” (refer to Paragraph 0011 of JP-A-2006-228723) is regarded as a problem requiring resolution, and as a solving means therefor, there is disclosed “a backlight module used in a display panel of a display device, wherein the concerned backlight module includes a light emission unit supplying light to the concerned display panel and a control unit regulating the amount of light from the light emission unit and, in response to any one display mode of a 2D image display mode, a 3D image display mode, and a mixed 2D/3D image display mode, arbitrarily controls the supplied amount of light from the concerned light emission unit by means of the concerned control unit” (refer to Paragraph 13 of JP-A-2006-228723).

### SUMMARY OF THE INVENTION

While a user is viewing a 3D video, there is the problem that there ends up arising great differences in video image brightness due to operations such as switching channels, on the occasion of video images getting switched to 2D, or depending on the difference in display method and the presence or not of spectacles. Further, if 3D display is chosen without checking whether the user has put on his spectacles, double images in which the left-hand and right-hand video images overlap end up being visible.

In JP-A-1995-336729, when the input is 3D video images, there is alternate switching between L (left) and right (R) images and the amount of light entering the eye is halved, so the image is dark, but when the input is a 2D video image, there is proposed a method of opening the shutters for both eyes; however, it is not described that there is a judgment whether the input video image is 2D or 3D, that there ends up being switching between 2D and 3D without judging whether the user has made a 3D display setting, or that there is regulation of the brightness in case the user is not carrying 3D glasses or counter measures against double images.

In JP-A-1995-336729, there is proposed backlight control at the time of carrying out switching from a 2D video image display mode to a 3D display mode, but since the ways and means of handling a situation with respect to dimming control at the time of 2D and 3D switching in conjunction with user manipulations are not described, differences in video image brightness end up being visible, with the timing of manipulations by the user.

Further, in JP-A-1995-336729 and JP-A-2006-228723, no description of dimming control of 3D video image display utilizing the ambient light and the existence or not of people is made, either.

In order to solve the aforementioned problems, one working mode of the present invention is provided with an input part with which e.g. video image information is input and a display part displaying the video image information input into the input part and is constituted to modify, over a prescribed period of time, the brightness of the displayed video images, if the displayed video images are switched from 3D video images to 2D video images.

According to the aforementioned means, it becomes possible to furnish video images that are easy to watch for the user.

### BRIEF DESCRIPTION OF THE DRAWINGS

FIG. 1 is a block diagram showing an example of the configuration of a display device of Embodiment 1.

FIG. 2 is a diagram showing a utilization configuration example of a display device of Embodiment 1.

FIG. 3 is an example of the processes of a display device of Embodiment 1.

FIG. 4 is a diagram showing a working example of L/R separation process 1 of a display device of Embodiment 1.

FIG. 5 is a diagram showing a working example of L/R separation process 2 of a display device of Embodiment 1.

FIG. 6 is a diagram showing a working example of L/R separation process 3 of a display device of Embodiment 1.

FIG. 7 is a diagram showing an example of processing of a display device of Embodiment 1.

FIG. 8 is a diagram showing an example of dimming control of a display device of Embodiment 1.

FIG. 9 is an example of an overlay process carried out in the L/R separation processing of a display device of Embodiment 1.

FIG. 10 is an example of a display of a display device of Embodiment 1.

FIG. 11 is a block diagram showing an example of the configuration of a display device of Embodiment 2.

FIG. 12 is a diagram showing an example of processing of a display device of Embodiment 2.

FIG. 13 is a diagram showing an example of processing of a display device of Embodiment 2.

FIG. 14 is a diagram showing a utilization configuration example of a display device of Embodiment 3.

FIG. 15 is a diagram showing an example of processing of a display device of Embodiment 3.

FIG. 16 is a diagram showing an example of processing of a display device of Embodiment 3.

FIG. 17 is a diagram showing an example of processing of a display device of Embodiment 4.

### DETAILED DESCRIPTION OF THE EMBODIMENTS

As three-dimensional video image display control methods devised to enable viewing of three-dimensional (3D) video images (3D video images) that utilize the parallax of the two eyes of a human being, there is e.g. a method in which a frame sequential scheme is used, in which images for the right eye and the left eye are output alternately for each screen in a display device and a liquid crystal shutter worn by the user is driven in adaptation thereto; and there are methods such as that of separating left and right images using polarized spectacles with circular polarization or linear polarization, utilizing the scheme of switching the polarization for each frame (circular polarization method or the like) in the display device, or the scheme of installing a polarized filter that differs for each pixel or line.

According to these methods, by having left and right video images with parallax and showing the same to the right and the left eye, and by making the left and right parallax three-dimensional in the brain, it is possible to show video images in three dimensions. Regarding 3D video image transmission techniques, various methods exist, there being the case where respective video images for the right and the left eye are transmitted at the same as the conventional data rate, i.e. at a data rate which is twice that of a conventional stream, but there are e.g. also the formats called “side by side” and “top and bottom” in which video images for the right and the left eye are displayed on the screen half and half at one time, and in this case, the data rate works out to that of one stream.

Also, in the liquid crystal shutter scheme, at the instant when the shutter is opened, the light only enters one eye, so the amount of light ends up being half of that of the actual video image and with the polarized spectacles, the transmittance is low and further, in one eye, only one side of the field can be seen, so the resolution and the amount of light end up diminishing. As a result, 3D video images viewed utilizing these spectacles end up looking dark to the user, compared to two-dimensional video images which are viewed without utilizing the spectacles.

Hereinafter, embodiments in which 3D video images are displayed utilizing spectacles will be described using the drawings.

### First Embodiment

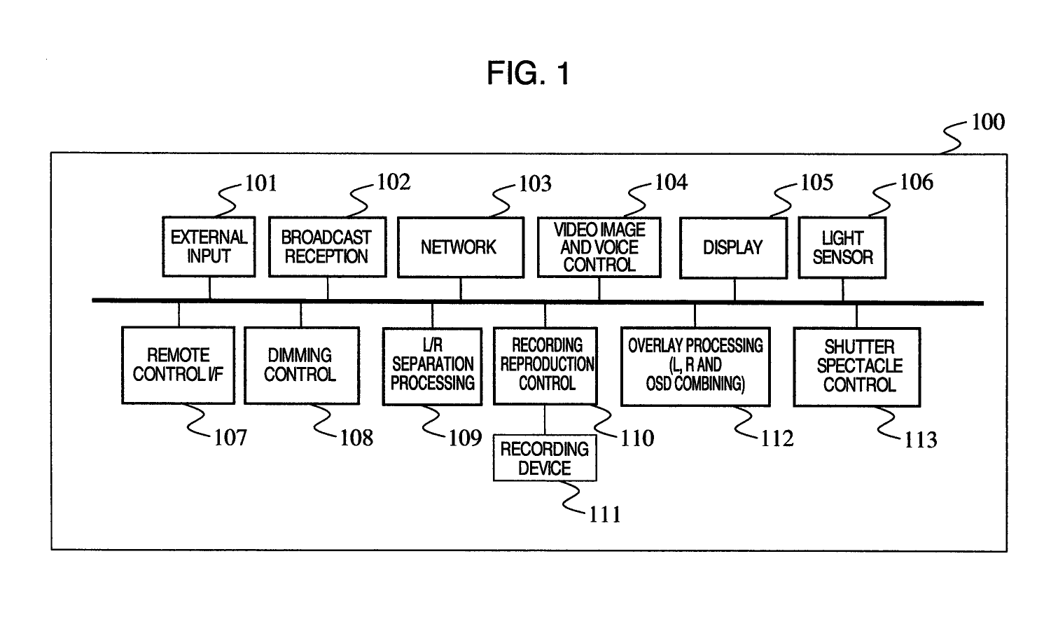

Hereinafter, Embodiment 1 will be described with reference to FIG. 1 to FIG. 10.

FIG. 1 is a block diagram showing an example of the configuration of a display device of Embodiment 1.

In FIG. 1, numeral 100 designates a three-dimensional display control device, 101 an external input part, 102 a broadcast reception part, 103 a network part, 104 a video and audio control part, 105 a display part, 106 a light sensor part, 107 a remote control I/F part, 108 a dimming control part, 109 a UR separation processing part, 110 a recording reproduction part, 111 a recording device, 112 an overlap processing part, and 113 a shutter spectacle control part.

External input part 101 is capable of inputting content such as video images, voice, and characters from a player device such as an optical disc or a game console. Broadcast reception part 102 can receive video, voice, or EPG (Electronic Program Guide) data or the like from radio, television, CATV (Cable Television), or the like with broadcast waves via a tuner device or the like.

Network part 103 is capable of receiving, via Internet or a home network, content or information such as video, voice, and characters. Voice and audio control part 104 carries out decoding processing, flow processing, or the like, of video, audio, and character information input from external input part 101, broadcast reception part 102, and network part 103 and carries out control of video images displayed in display part 105, video storage in recording device 111, and reproduction of the stored video images, in cooperation with recording reproduction control part 110.

Display part 105 is a display device with liquid crystals, organic EL (electroluminescence), plasma, LED (Light Emitting Diodes), or the like, which displays video images controlled with video and audio control part 104 and overlay process part 112 with a brightness controlled by light sensor 106 and dimming control part 108.

Light sensor 106 is a sensor detecting ambient brightness. Normally, in case the surroundings are dark, and the video image is shown bright, the brightness in display part 105 is reduced, since the user ends up feeling blinded, but on the contrary, if the surroundings are bright and if the video image is not made bright, it ends up being perceived as difficult to see. In this way, by detecting brightness with light sensor 106 and performing display control, with brightness adapted to the surroundings, it is possible to mitigate the difficulty of seeing.

Remote control I/F part 107 is an interface receiving input et cetera from the remote control manipulating the three-dimensional display control device. Dimming control part 108 is a control part regulating the brightness of the video images of display part 105. If display part 105 is a liquid crystal panel or a LED panel, it regulates the backlight or the LED brightness, enabling it to regulate the video image brightness. As for plasma or organic EL displays or the like, it regulates the emitted light output, making it possible to regulate the video image brightness.

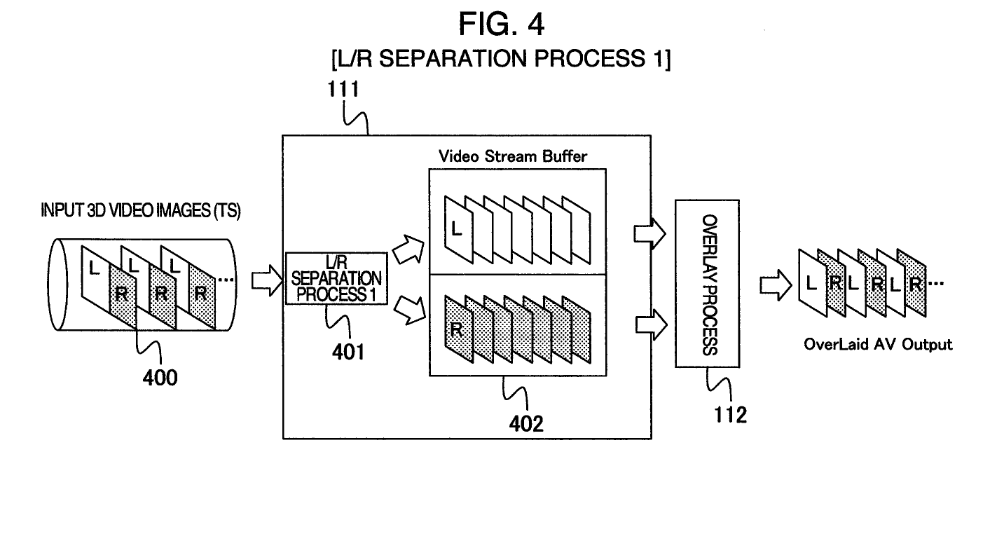

L/R separation processing part 109, as shown in FIG. 4 to FIG. 6, carries out processing to separate a 3D or 2D transport stream (TS) into two video stream buffers and progressively store the same. It acquires synchronization, and performs overlay process 112, of the accumulated video stream buffer, and outputs the same to display part 105.

Recording reproduction control part 110 carries out control to record video, audio, and character information input from external input part 101, broadcast reception part 102, and network part 103 in recording device 111 and performs operations like utilizing video and audio control part 104 to reproduce video, audio and character information recorded in recording device 111. Recording device 111 is composed of a Hard Disk Drive (HDD) or memory or the like, made up of semiconductor elements such as a Solid State Disk (SSD), has a directory structure, and is capable of recording video, audio, and character information in file units.

Overlay process part 112 combines the video stream separated in L/R separation processing part 109 with display items such as menu screens manipulated by the user or subtitles overlaid on the video image, and displays the same to display part 105. Shutter spectacle control part 113 controls signal transmission for acquiring the synchronization of the opening and closing of the left and right liquid crystal shutters of the liquid crystal shutter spectacles in conjunction with 3D display control device 100.

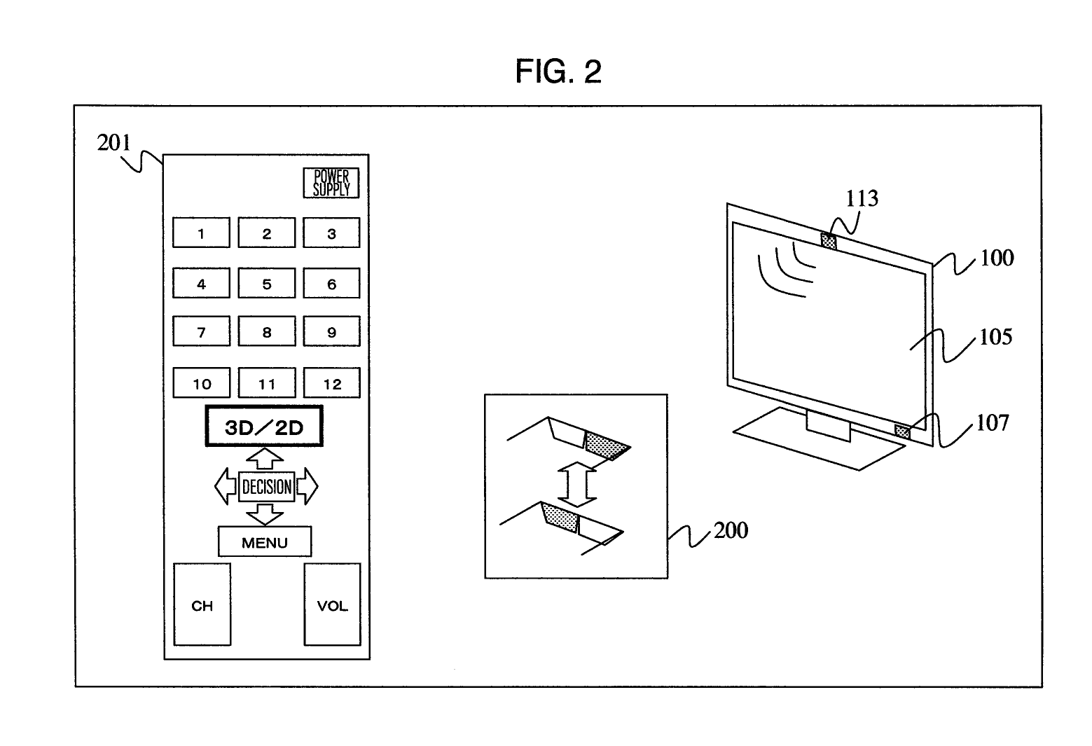

According to the present configuration, the control operations in FIG. 2 to FIG. 10 below are taken to be possible, so, by carrying out switching of the display method in the display part and dimming control, in response to manipulations by the user to switch between 2D and 3D and to whether the input is 2D or 3D, it is possible to mitigate the difference in brightness between 2D and 3D video images on the occasion of putting on spectacles for 3D viewing and to regulate the brightness without any sense of discomfort even after taking off the spectacles.

FIG. 2 is a diagram showing a utilization configuration example of a display device of Embodiment 1. In FIG. 2, numeral 200 designates liquid crystal shutter spectacles and 201 a remote control device.

It is a configuration example utilizing three-dimensional display control device 100, liquid crystal shutter spectacles 200, and remote control device 201, in which the user can view 3D video images. The signal from remote control device 201 is an infrared (IR) signal which is sent to remote control I/F 107 and, in response to remote control manipulations, three-dimensional display control device 100 carries out control.

The user utilizes remote control device 201 to select whether to choose 3D display or 2D display. In case the video image that the user is attempting to view is 3D and he wants to choose 3D display, the user presses the 3D/2D button of remote control device 201 to switch from 2D display to 3D display. During 3D display, a video image for the right eye and a video image for the left eye are displayed alternately in time in display part 105.

A control signal for combining the left and right image display timing of display part 105 and the left and right opening and closing of the liquid crystal shutters of liquid crystal shutter spectacles 200 is transmitted with infrared radiation or the like. Liquid crystal shutter spectacles 200 having received the same acquire synchronization with the signal and control the opening and closing of the left and right liquid crystal shutters.

According to these operations, it is possible to show an image for the right eye to the user's right eye and an image for the left eye to his left eye and the user configures the image seen with the right eye and the image seen with the left eye in his brain and artificially perceives a three-dimensional video image, so he can enjoy 3D video images.

In the present example, the On/Off choice of the 3D display setting is carried out by means of manipulation of the remote control, but it is also possible to enable modifications of the 3D display setting by manipulating the user manipulation device built into the display device.

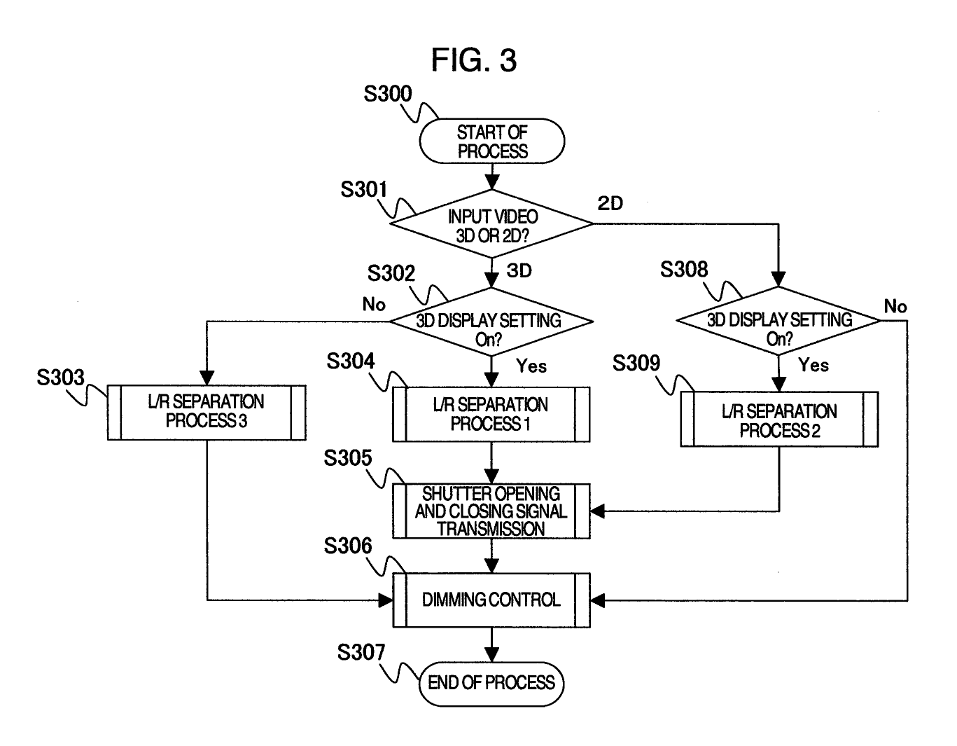

FIG. 3 is an example of the processing of a display device of Embodiment 1.

The present processing sequence is a sequence to switch video image signal processing by means of the class of input content (2D/3D) and the user's selection of 2D or 3D display.

In Step S300, it is the start of the process and in Step S301, it is judged whether a video image input from external input part 101, broadcast reception part 102, or network part 103 is 3D or 2D. For this judgment, 2D and 3D information may be included in the content header information or it may be judged by means of TS analysis that the input is 3D from the number of frames included in a unit of time or from a situation such as that of two similar video images being overlaid, whereas other cases may be taken to be 2D.

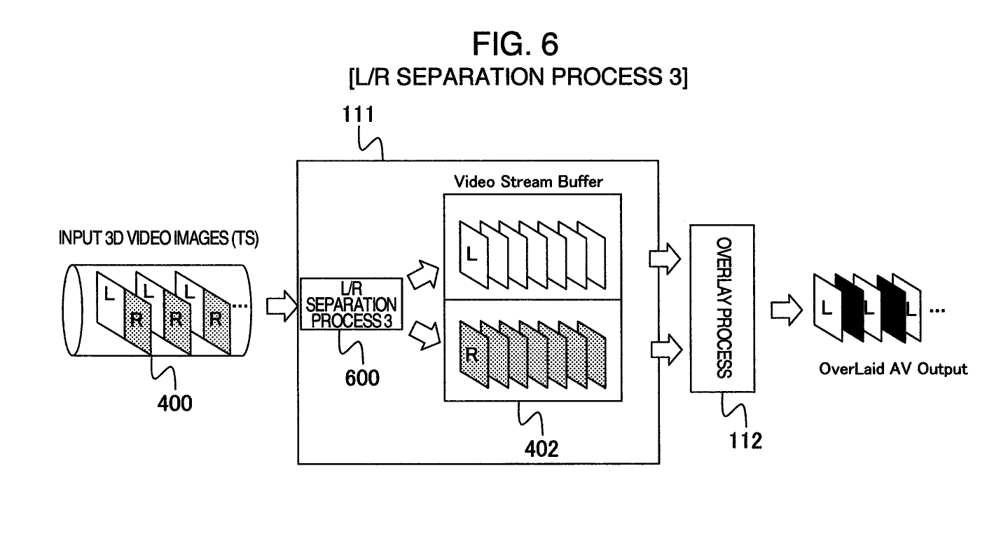

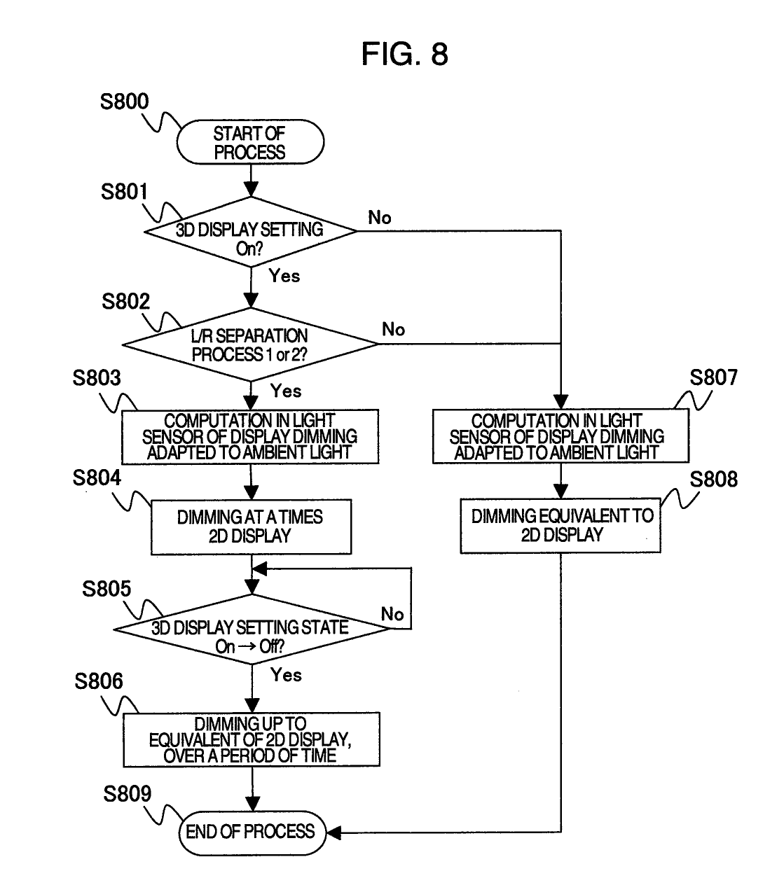

In case the video image is 3D in Step S301, it is judged in Step S302 whether the user has chosen “On” for the 3D display setting. In case the user has chosen “Off” for the 3D display setting, L/R separation process 3 shown in FIG. 6 is carried out in Step S303 and dimming control processing shown in the sequence of FIG. 8 is carried out (Step S306).

Specifically, in display part 105, even though the input video image is 3D, 2D display is carried out and the same dimming control adapted to the ambient light as during 2D display is carried out, control being carried out as for when the user is viewing a 2D video image ordinarily without wearing the spectacles. In this way, even though the input video image is 3D, it is possible for the user to view the video image as 2D without wearing the spectacles and without any difference in video image brightness.

In case the user has chosen “On” in the 3D display setting in Step S302, L/R separation process 1 is carried out in Step S304 and a liquid crystal shutter opening and closing signal is transmitted from shutter spectacle control part 113 (Step S305), and dimming control is carried out with the sequence shown in FIG. 8 (Step S306).

Specifically, the left and right images of a 3D input video image are displayed alternately in display part 105, the timing of the same left and right images is adapted, and the liquid crystal shutter is controlled, so the video image can be viewed as 3D. On this occasion, at the instant when the shutter opens, since the light only enters one eye, the actual video image light quantity ends up being halved, resulting in a dark video image, dimming control is carried out so that the brightness of the video image becomes A times greater than during 2D display. At this juncture, since the video image becomes dark in an instant at the instant when the spectacles are put on, dimming control is carried out immediately to also raise the video image brightness.

In this way, the user puts on the spectacles and, in a state where preparations are made for the start of 3D display, he makes a 3D display selection and alternate left and right video images are respectively projected to the left and right eye, making it possible to enjoy the video image as a three-dimensional video image.

In case the video image is judged to be 2D in Step S301, it is checked in Step S308 whether the user has chosen “On” for the 3D display setting and in case the use has selected a 2D setting, there is carried out dimming control as during normal 2D display within Step S306, so 3D processing is not implemented. Specifically, in the case where the input video image is 2D and the user has not selected a 3D display setting, normal 2D display control is carried out, without doing anything.

In case the user has selected a 3D display setting in Step S308, L/R separation process 2 of Step S309 is carried out and the dimming control of Step S306 is carried out. Specifically, even though the input video image is 2D, it is the case that the user is wearing spectacles and has selected a 3D display setting, so at this juncture, an image that is a duplication of the image for the left eye is taken as the image for the right eye (duplication of the image for the right eye also being acceptable), there are not alternately displayed L and R images but L and L images are displayed alternately, and shutter opening and closing control is carried out, so he can enjoy 2D video images while keeping the spectacles on. At this juncture, since he is wearing the spectacles, and since the video images become dark, in the dimming control of Step S306, the dimming control is carried out so that the brightness of the video images becomes A times that during 2D display.

In this way, even though he is wearing spectacles and is viewing video images, he can view 2D video images with the same brightness as if he were viewing 2D video images not wearing spectacles.

According to this processing sequence, it is possible, in a state in which the user is not wearing spectacles, for the user to continue the viewing images as 2D video images which have fixed video image brightness, even if there is a transition in the input video images from 2D to 3D, or from 3D to 2D.

Also, even when the user is wearing spectacles and has chosen “On” as the 3D display setting, and even if the input video images make transitions between 2D and 3D, he can continue the viewing of 3D or 2D video images with a fixed video image brightness.

E.g., if he is wearing spectacles and has chosen “On” as the 3D display setting, in case the user switches channels in the midst of enjoying 3D video images by using a remote control device or the like and the channel being switched to had 2D video images, there is the problem that the video images end up looking dark if he watches 2D video images in a state with his spectacles on since the transmittance of the spectacles is also low, but if the present control scheme is utilized and L/R separation process 2, shutter control, and dimming control are carried out, there is the merit of being able to continuously view 2D video images in a state with the video image brightness kept fixed, even if the channel being switched to has 2D video images.

Also, in this way, until the user selects a 3D display setting, 2D display is performed and double video images in which L and R images are apparently overlaid are not displayed, so there is also the effect for the user that video images which are difficult to view are not shown.

FIG. 4 is a diagram showing a working example of L/R separation process 1 of a display device of Embodiment 1.

L/R separation process 1 is a process in which 3D video images are input as input video images with TS 400 and a video stream capable of 3D display is output. As the input of L/R separation process 1 (401), a 3D video image TS is input into two video stream buffers inside L/R separation process 111, the L and R images are separated, and the video images are accumulated. The video images of the buffer are synchronized with the L and R display timing, are progressively arranged time sequentially, adding offset information such as menu or subtitle information, effectuating an overlay process, and combining the same to carry out video output.

As for this process, by respectively separating at 60 Hz the L and R components of e.g. a side by side stream which is input at 60 Hz and arranging the same time sequentially, a stream corresponding to 120 Hz is generated.

In order to improve the resolution of a moving image, double-speed display with frame rate conversion is carried out and displayed to display part 105 driven at a rate corresponding to 240 Hz. It is a processing method for the case where the L and R images of the liquid crystal shutter spectacles are also controlled to be opened and closed alternately at 240 Hz, the same as for the display part, and video images with parallax are shown to the left and right eye and shown to the user as 3D video images.

In the present example, an input 3D video image is described with “side by side”, but both the case where the respective video images for the right and left eye are gradually sent at the same data rate as conventionally and a format of at one time displaying half and half video images for the right end the left eye to the screen, also called “side by side” and “top bottom”, can be implemented with the same scheme (FIG. 6 also being the same).

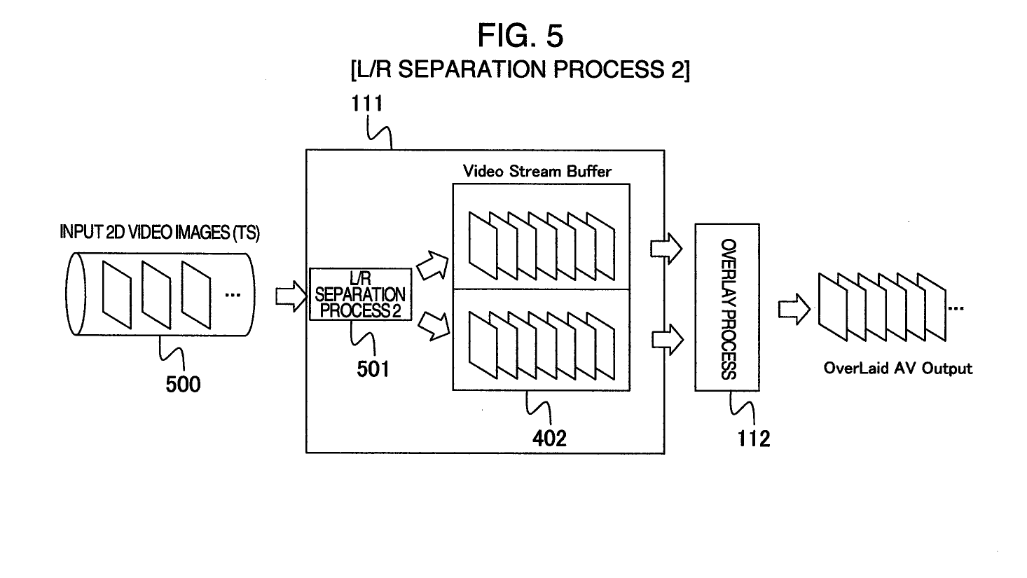

FIG. 5 is a diagram showing a working example of L/R separation process 2 of a display device of Embodiment 1.

L/R separation process 2 is a process in which 2D video images are input with TS 500 as input video images and a video stream capable of 2D display is output with the same scheme as for 3D display. As an input of L/R separation process 2 (501), a 3D video image TS is input and video images which are duplicated from L (or R) images and L (or R) images are saved in two video stream buffers inside L/R separation processing part 111.

With 3D display and the same timing as when L and R images are displayed, the buffer video images are gradually arranged time sequentially in a video stream of L (or R) images, offset information such as menu or subtitle information is added and combined by an overlay process, and video output of the result is performed.

This process e.g. separates at 60 Hz a 2D video image stream that is input at 60 Hz into two frames, one frame and a duplicated frame thereof, and arranges the same time sequentially, and generates a stream corresponding to 120 Hz. In order to improve the resolution of moving images, it carries out double-speed display with frame rate conversion and makes the display to display part 105 which is driven at the equivalent of 240 Hz.

It is a processing method for the case where liquid crystal shutter spectacles are also controlled to alternately open and close the L and R images at 240 Hz, the same as for the display part, and video images with parallax are shown to the left and right eye to show the same as 3D video images to the user.

FIG. 6 is a diagram showing a working example of L/R separation process 3 of a display device of Embodiment 1.

L/R separation process 3 is a process in which 3D video images are input with TS 400 as input video images and a video stream of a scheme to view regular 2D video images without wearing spectacles is output. As an input of L/R separation process 3 (600), a 3D video image TS is input and video images are separated into L and R images and saved in two video stream buffers inside L/R separation processing part 111. When the buffer video images are synchronized, with the L and R display timing, and arranged time sequentially, with the timing to insert the R (or L) images, either nothing is inserted, or black video images are inserted, and offset information such as menu and subtitle information is added and combined by an overlay process, and video output of the result is performed.

This process generates the equivalent of a 120 Hz stream by e.g. separating at 60 Hz the L and R images of a “side by side” stream that is input at 60 Hz and by arranging the same time sequentially and is an example of a method to insert black frames with the timing of inserting R images of FIG. 4 on the occasion of generating the stream.

It is a processing method for the case of also, for the liquid crystal shutter spectacles, controlling the opening and closing alternately of L and R images with the same operating frequency as that of the display, showing video images with parallax to the left and right eye and showing the same as 3D video images to the user.

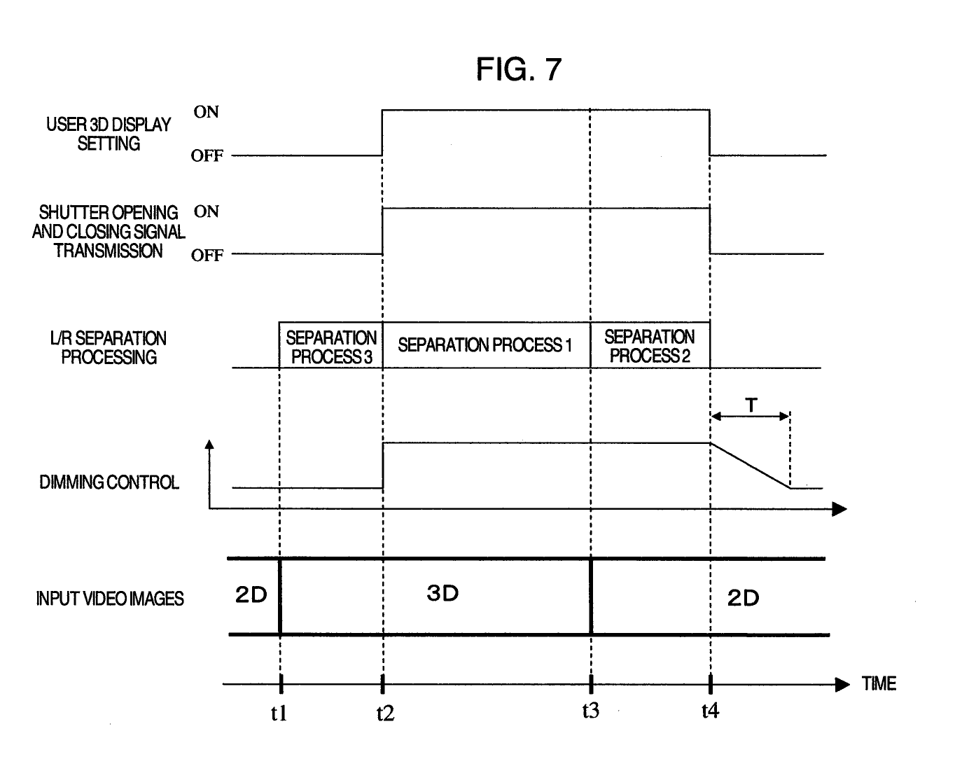

FIG. 7 is a diagram showing an example of processing of a display device of Embodiment 1.

In FIG. 7, the abscissa represents the time direction. It is an example of a situation in which video images input from external input part 101, broadcast reception part 102, and network part 103 are switched from 2D to 3D, and again to 2D.

Regarding this video image switching, it is considered for the case where a broadcast station side or the video image provider side inserts a 2D commercial message (CM) during a 3D program, the case where the utilizes the remote control device switches channels to a 2D program while viewing a 3D, or the like.

First, in the period of time preceding time t1, 2D video images are input. At this juncture, 2D video image processing such as decoding of the input video images is performed without carrying out L/R separation processing and 2D display is carried out. At time t1, in case the user performs an operation like switching channels and the input video images change to 3D, a TS including L and R video images is input and L/R separation process 3 performing the same output processing as for 2D video image display is carried out.

At time t1, since the situation is one in which the user has not yet selected a 3D display setting, and because it can be considered that there is no preparation for viewing 3D video images (a state in which the display device is viewed without wearing spectacles), transmission of a shutter opening and closing signal has not started and output processing which is the same as for 2D video image display and dimming control corresponding to that during 2D display are carried out.

In this way, as for display part 105, the result is that there is a state in which there continues a display method which is the same as the 2D display at or before t1 and even if the input video images switch from 2D to 3D, the user does not feel any difference in the brightness of the video images and can continue viewing the video images without any discomfort.

It is an example of a case where, from time t1 on, the input is 3D video images, the broadcast station or the like notices screen display information to the effect that “3D” video images are broadcast, probably included in the video image information, and at time t2, the user puts on his spectacles and performs the manipulation of choosing the 3D display setting to be “On”.

In this case, in conjunction with the user's 3D display setting being “On”, the transmission of a shutter opening and closing signal is started and L/R separation process 1 carrying out 3D display is started in order to enable viewing of 3D video images. On this occasion, in order to prevent the video images from becoming dark due to the wearing of spectacles, the brightness of the video images is controlled by the dimming control to be A times higher, and there is carried out regulation so that, even if the user is watching through spectacles, the brightness looks the same as that of the 2D display being displayed at the time before time t2.

In this way, the darkness of the video images due to the wearing of spectacles is solved and it is possible to view 3D video images with the same brightness as that of the 2D images viewed at or before t2.

At the subsequent time t3, the user performs an operation like switching channels and in case the input changes from 3D to 2D, the 3D video images of the input are L/R separation processed and there starts L/R separation process 2 in which only the L images, one side of the L and R images, are displayed.

In this case, since the user has left the 3D display setting “On”, and because it is assumed that he is viewing while carrying spectacles, the opening and closing control of the shutter spectacles, the method of displaying to display part 105, and the dimming control are carried out with the same display method as that for the 3D images viewed so far. In L/R separation process 2, the display is carried out, as shown in FIG. 5, with the same output timing as that of L/R separation process 1 during the 3D display shown in FIG. 4 and through the shutter spectacles, it is possible to watch the video images, but since there is parallax in the L and R video images, the brightness of the video images is not changed with respect to that during the 3D display, and 2D display becomes possible.

At the subsequent time t4, in the case where, since the user does not perceive any parallax in the video images even if he is viewing with the spectacles on, he notices that the input video images are 2D and, using the remote control, chooses the 3D display setting to be “Off” to switch to 2D display, it can be assumed that the state is one in which the user has taken off the spectacles, so the shutter opening and closing signal transmission is halted, L/R separation processing is further also halted, and 2D display processing is carried out.

At this juncture, in case the user removes the spectacles at t4, with the assumption that the spectacles are worn at the time before t4, the result is that the video images end up looking too bright, since dimming control is performed to make the video images A times brighter. Because of that, there is a need to return to the 2D display dimming during the 2D display at or before t1, but since the user would feel a sense of discomfort if there is a return all the way to 2D display dimming immediately, dimming control is performed over a period of time T and the brightness of the video images is reduced gradually.

In this way, it is possible to regulate so that there is no discomfort as the brightness increases up to the same brightness as that for a regular 2D viewing environment.

At time t2, since spectacles are worn, even if the video images become brighter at once, it is difficult for the user to feel blinded, but in the state at time t4 in which the spectacles are removed, but in case the user chooses “Off” as the 3D display setting, dimming control is performed over a period of time T and the situation is handled by gradually reducing the brightness of the video images, since he would feel a sense of discomfort if the video images were to become dark immediately.

In this way, the result is that it becomes possible to regulate the brightness in adaptation to a regular 2D viewing environment without any sense of discomfort.

FIG. 8 is a diagram showing an example of dimming control of a display device of Embodiment 1.

First, in Step S801, in case the user checks whether the 3D display setting is at “On” and the 3D display setting is at “On”, the processing in L/R separation processing part 111 judges, in Step S802, whether the process is L/R separation process 1 or 2, processes during a state in which the spectacles are worn.

In the case of L/R separation process 1 or 2, the ambient light is detected with light sensor 106 in Step S803 and 2D display dimming adapted to the ambient light is computed.

Next, in Step S804, the 2D display dimming computed in Step S803 is further dimming controlled to bring it A times higher.

In this way, even if the spectacles are worn, it becomes possible to display the video images with a brightness that is the same as during 2D display adapted to the ambient light.

When display is performed with dimming control at A times the normal, in case the user has chosen “Off” as the 3D display setting (Step S805), it is considered that there is a situation in which the user has removed the spectacles. Because of that, since it ends up looking too bright for the user with dimming control at A times the normal, there is a need to change from dimming at A times the normal to dimming at 1 times the normal, but if the dimming ends up getting performed immediately, dimming control is carried out over a period of time T until the input becomes the same as during video image display in the case where the input is 2D, since the user would feel a sense of discomfort due to the fact that the video images have suddenly become more dark (Step S806).

In Step S801, in the case where the user has not made a 3D display setting, or in the case with L/R separation process 3 for which it is assumed a case where the spectacles are not worn in Step S802 or with no L/R separation process, the ambient light is detected with light sensor 106, the 2D display dimming adapted to the ambient light is computed (Step S807), and, on the basis of the computed result, there is carried out dimming control to the level during video image display in the case where the input is 2D (Step S808).

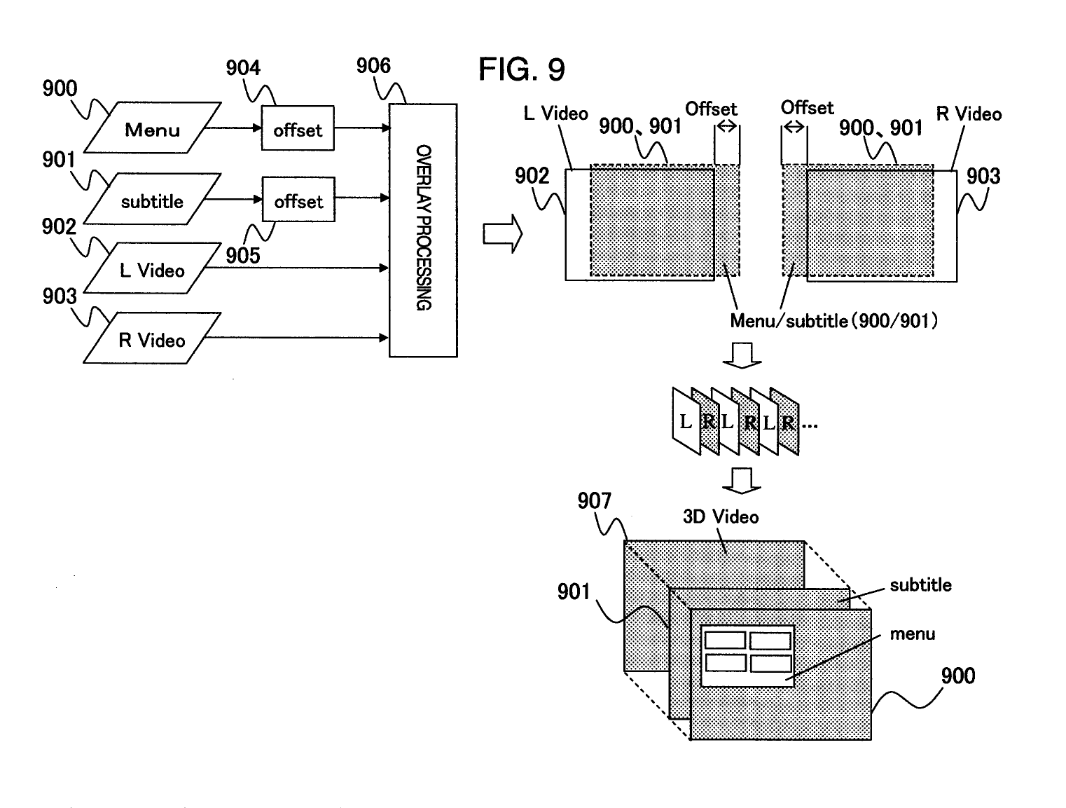

FIG. 9 is an example of an overlay process carried out in the L/R separation processing of a display device of Embodiment 1.

Numeral 900 designates a menu screen, 901 subtitles, 902 a video stream for the left eye, 903 a video stream for the right eye, 904 an offset information item showing the left and right parallax for regulating the parallactic display level of the menu, 905 an offset information item showing the left and right parallax for regulating the parallactic display level for subtitles, 906 an overlay processing part, 907 a 3D video display screen, 901 a subtitle display screen, and 900 a menu display screen.

Concerning the respective L and R video streams 902 and 903, by generating a signal in which menu and subtitle offsets 904 and 905 are added, arranging the left and right sequentially, and displaying the same with the display part, the eyes perceive the parallax, so a video image representation having a three-dimensional feeling becomes possible.

The offset values of the menu and subtitle parallactic display levels of offset information items 904 and 905 may be included in the input video images or the parallactic display level of the video images from the misalignment of video streams 902 and 903 may be computed and the menu and subtitle offset values may be computed conjunctively with the same pop-up display values.

The menu and subtitle parallactic display level is made greater than the parallactic display level of the video images, the menu and subtitles are displayed more in the foreground than the video images are, et cetera, and the depth arrangement for showing it to the user is carried out with an overlay process.

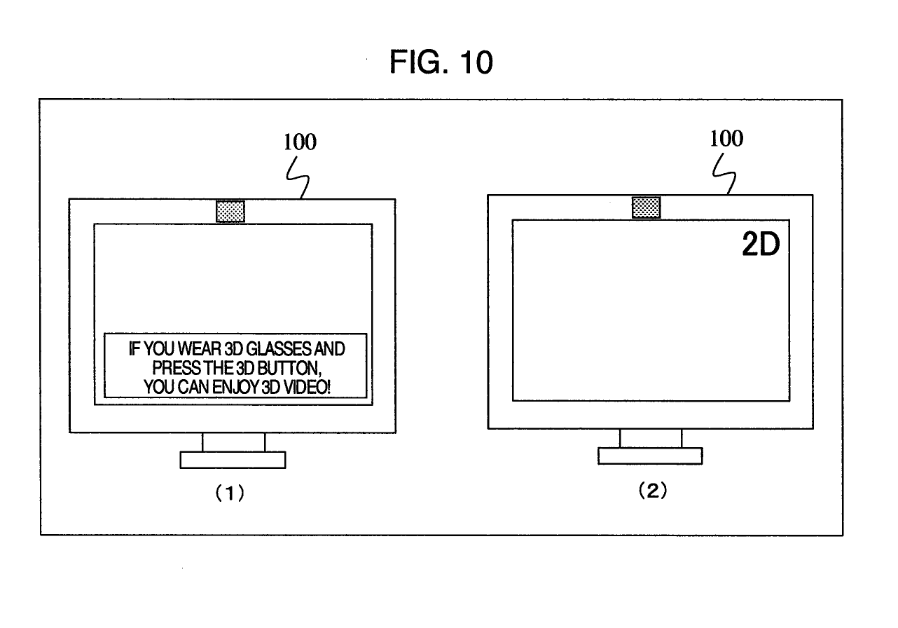

FIG. 10 is an example of a display of a display device of Embodiment 1.

Case (1) in FIG. 10 is an example of a message provided to the user between time t1 and t2 in FIG. 7. It is a case in which the input video images are 3D, but the situation is that the user has not chosen “On” as the 3D display setting, the spectacles are not worn, and the video images are viewed as 2D.

In a case like this, since it is also a timing at which to enjoy 3D images, it is an example of inciting the user: “If you wear 3D glasses and press the 3D button, you will be able to enjoy 3D video.” It is considered that this message is output with a scheme like a pop-up display while 2D video images are being viewed.

Case (2) in FIG. 10 is an example of a message that is presented to the user between time t3 and time t4 in FIG. 7. The user is wearing spectacles and is viewing 3D video images until time t3, but in case the viewed video images are switched to 2D due to the end of a program or a channel switch, there is a “2D” message notifying the user of the fact that the audiovisual images are 2D.

The user watches a “2D” display, chooses the 3D display setting to be “Off” and removes the spectacles. In the sequence of FIG. 3, between time t3 and t4, even if he wears spectacles, 2D display can be viewed, and since the need to wear spectacles disappears, it is a message to notify the user thereof.

These messages may be displayed the whole time continuously, from time t1 to time t2 for Case (1) of FIG. 10 and from time t3 to time t4 for Case (2) of FIG. 10, or the user may be able to manually set the message display to “Off”, or the message may be set to “Off” automatically after the message has been displayed for a certain period of time.

### Second Embodiment

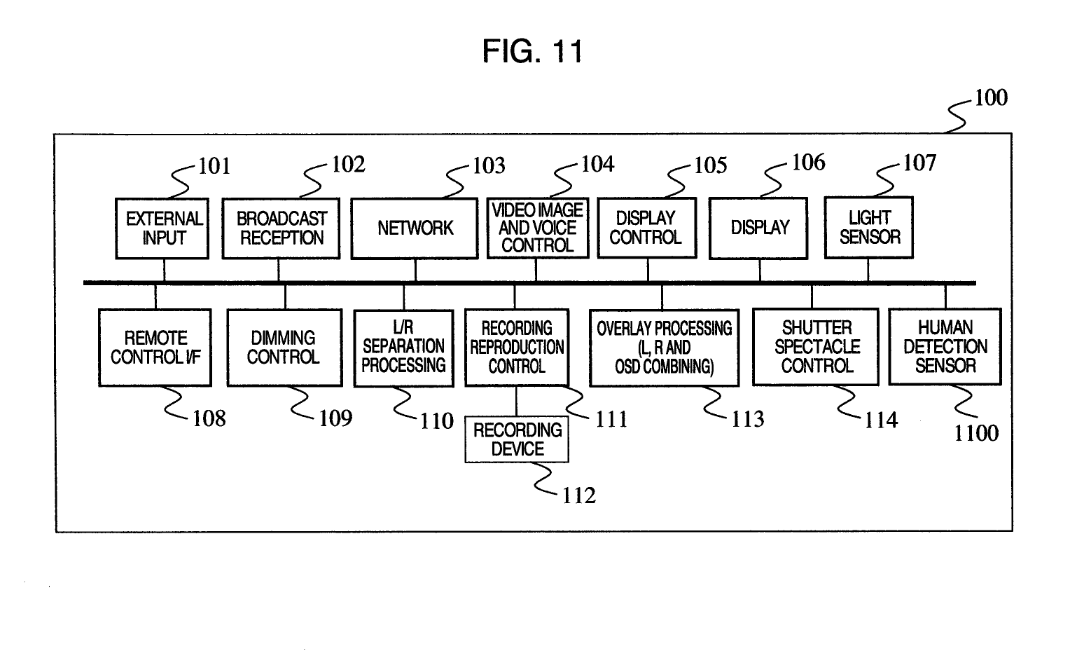

Hereinafter, Embodiment 2 will be described with reference to FIG. 11 to FIG. 13.

FIG. 11 is a block diagram showing an example of the configuration of a display device of Embodiment 2, the configuration being one in which a human detection sensor 1100 has been added to FIG. 1, the configuration example of Embodiment 1.

Human detection sensor 1100 is composed of a human sensor or a camera sensor and a microphone sensor, and detects, inside the detection area, the presence or absence of human beings, or the viewing situation, the number of viewers, viewer identities, and the like.

According to the present configuration, there is made possible a function by which the 3D display setting is automatically chosen to be “Off” in case the user is no longer present while the 3D display setting is “On”. As for this, it can be considered that, in the case where the user has some errand and has left his seat and is no longer in the viewing area during 3D display, there are many cases where he has removed the 3D spectacles.

In a state with the 3D spectacles removed, since there is the problem that the video images end up looking like double images with L and R images overlapping when he returns to the video image viewing area and 3D display is chosen (resumed), the 3D display setting is automatically chosen to be “Off” if the user becomes absent, the result being a mechanism for not making a 3D display until the user returns to his seat and for a second time chooses the 3D display setting to be “On”.

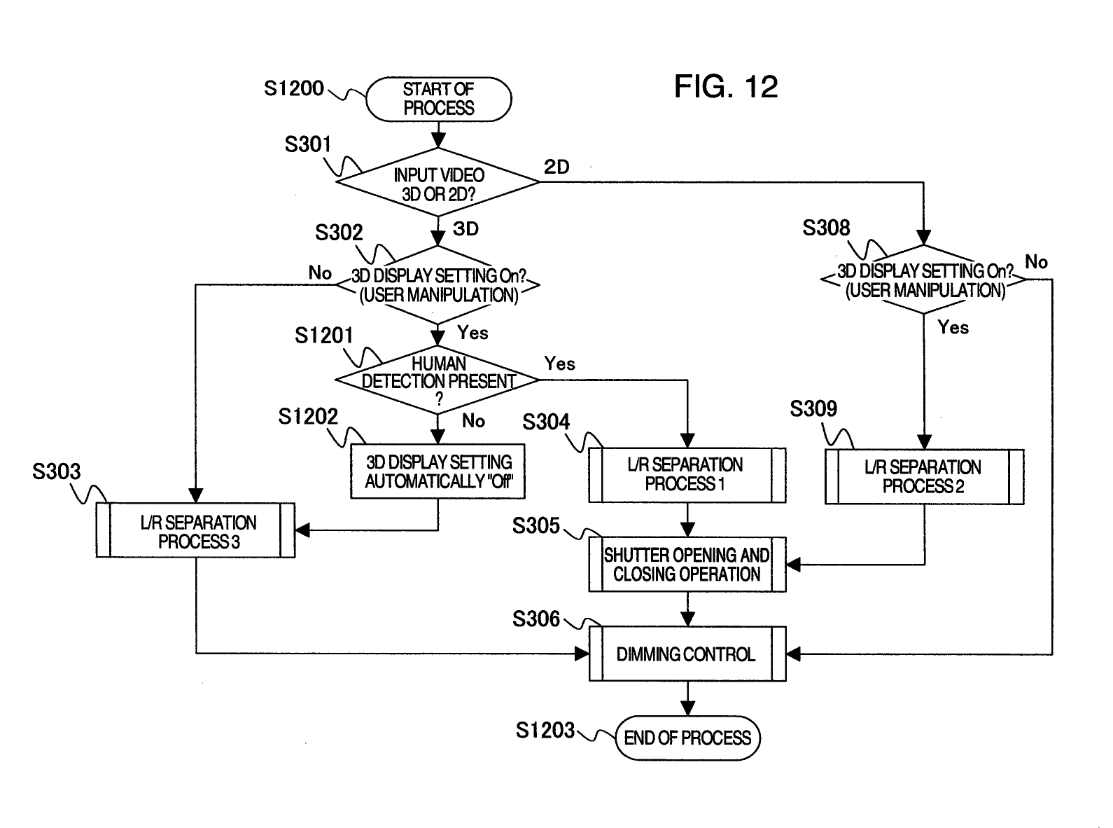

FIG. 12 is a diagram showing an example of processing of a display device of Embodiment 2.

The same references are utilized as for the processes of Embodiment 1 described in FIG. 3. What is added to the sequence of FIG. 3 is that, in case the user chooses a 3D display setting in Step S302, a human detection sensor is utilized in Step S1201, the process being one of judging whether there is presence or not of human detection.

In Step S1201, in case it is judged that there is no human detection, the 3D display setting is automatically chosen to be “Off” in Step S1204, L/R separation process 3 is started (Step S303), 2D display is carried out, and dimming control adapted to the ambient light with no 3D spectacles worn is carried out (Step S306).

In this way, even when the user has returned to the video image viewing area, the result is that until the user puts on the spectacles for a second time and chooses the 3D display setting to be “On”, 3D display is not chosen, so when the user removes the spectacles and returns, he gets by without seeing double images with L and R images overlapping.

In the case where there is no human detection, after Step S303, by reducing the brilliance of the display screen automatically or muting the screen, the system may have an electric energy conserving mechanism. At this juncture, also, when the user returns and the screen is making a display, by carrying out 2D display rather than 3D display, the naked eye will get by without seeing double images with L and R images overlapping.

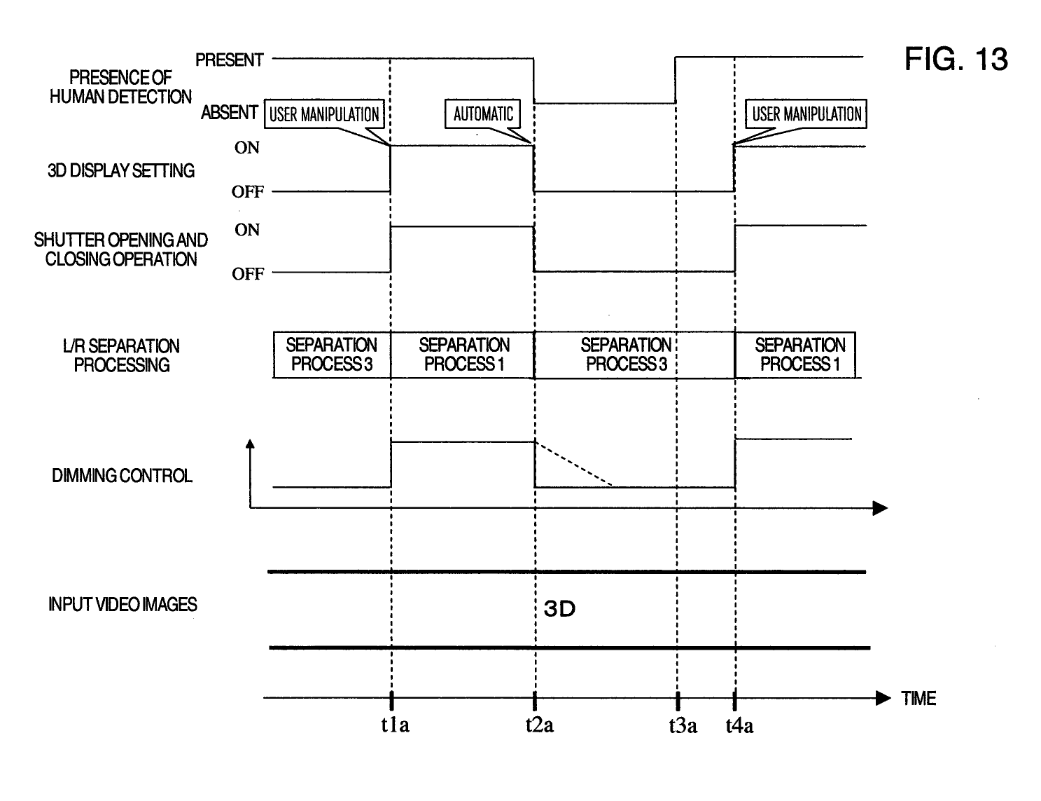

FIG. 13 is a diagram showing an example of processing of a display device of Embodiment 2.

In FIG. 13, the abscissa represents the time direction. It is an example in which the video images input from external input part 101, broadcast reception part 102, or network part 103 are 3D images. E.g., it is a setting where a 3D broadcast is received with broadcast waves and viewed or a situation in which network content is distributed in 3D or 3D video images stored in media are viewed.

The time at or before time t1a is a situation before the user has chosen a 3D display setting and 2D display is carried out by means of L/R separation process 3 which is the same as the process from time t1 to time t2 in FIG. 7. At time t1a, in case the user chooses “On” for the 3D display setting, in the time period from time t1a until time t2a, 3D display processing is carried out and dimming control is carried out so that the images look bright, even if the spectacles are worn.

At time t2a, in case the human detection reaction disappears for a reason such as the user leaving during 3D display, the 3D display setting is automatically chosen to be “Off”. Also, at this juncture, since the user is absent, the shutter opening and closing operation is also chosen to be “Off”.

Since the 3D display setting has become “Off” because of a detection of absence, the brightness of the video images is regulated and is reduced to the equivalent for 2D display and, since the user is absent, the dimming is reduced immediately in this case.

At time t2a, not only when there is a detection of absence by the human detection sensor but in case it is detected, using a camera or the like, that the user has fallen asleep while wearing the spectacles, a method can be considered in which the display does not become dark immediately but slowly becomes gradually darker. Even if the user has fallen asleep, but since there are cases where he ends up waking up if it becomes dark immediately, it can be considered to handle the situation by gradually making it darker so as not to wake up the user from his doze.

When the user, at time t3a, comes back with the spectacles removed, it is possible to view the video images with dimming corresponding to 2D display. In case the user comes back with the spectacles on, it becomes an opportunity for the user to choose the 3D display setting to be “On” since the video images look dark, so there is also the effect that it is possible to resume 3D viewing.

When the user returns at time t3a, it is acceptable to display a message like in Case (1) of FIG. 10 and to incite the user to make a 3D display setting. In response to these incitements, at time t4a, in case the user chooses “On” for the 3D display setting, 3D display processing is started.

### Third Embodiment

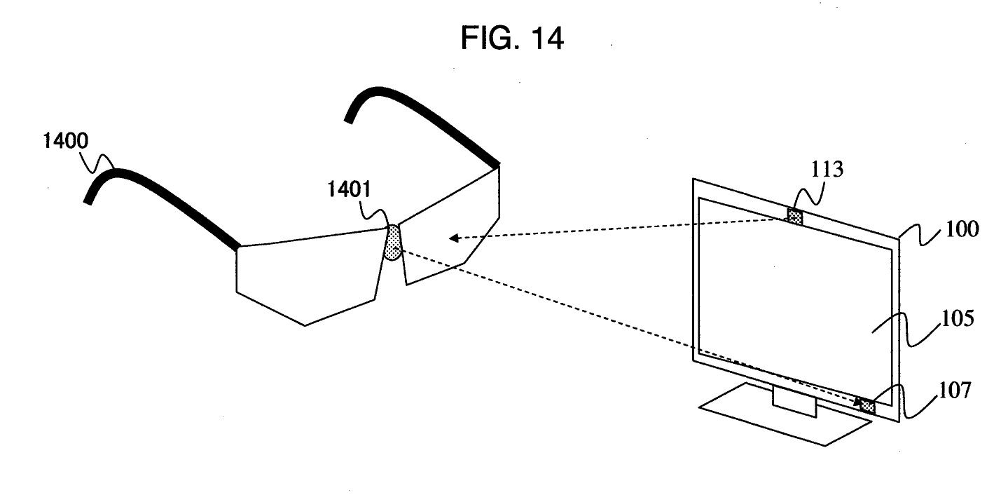

Hereinafter, Embodiment 3 is described with reference to FIG. 14 to FIG. 16.

FIG. 14 is a diagram showing a utilization configuration example of a display device of Embodiment 3.

Numeral 1400 designates a pair of 3D spectacles (also called “viewing device”) used for viewing 3D video images and 1401 is a switch detecting that the user is wearing the 3D spectacles. 3D spectacles 1400 acquire synchronization from a left and right shutter opening and closing signal, from shutter opening and closing signal transmission part 113 with which three-dimensional display control device 100 is equipped, to carry out opening and closing control of the left and right shutter.

As for numeral 1401, there can be considered items like an electrostatic touch switch or a relay switch. The mechanism is one in which the switch is automatically pressed due to the fact that the user puts on the spectacles. If switch 1401 is pressed, it transmits a spectacle mounting signal to remote control I/F 107 with which three-dimensional display control device 100 is equipped to communicate to three-dimensional display control device 100 that the user has put on the spectacles.

In Embodiments 1 and 2, turning the 3D display setting “On” and “Off” required user manipulation, but in this way, there is the merit that 3D display can be started even if there is no user manipulation, taking the opportunity of the fact that the user has put on the spectacles.

Also, in Embodiments 1 and 2, even in a situation where it is not known whether the user is actually wearing the spectacles, since 3D display ends up starting at the timing of the user's choosing the 3D display setting to be “On”, if he is not wearing the spectacles, double images with L and R images overlapping end up being shown to the user, but if the existence of mounting can be detected on the spectacles, the aforementioned problem is solved.

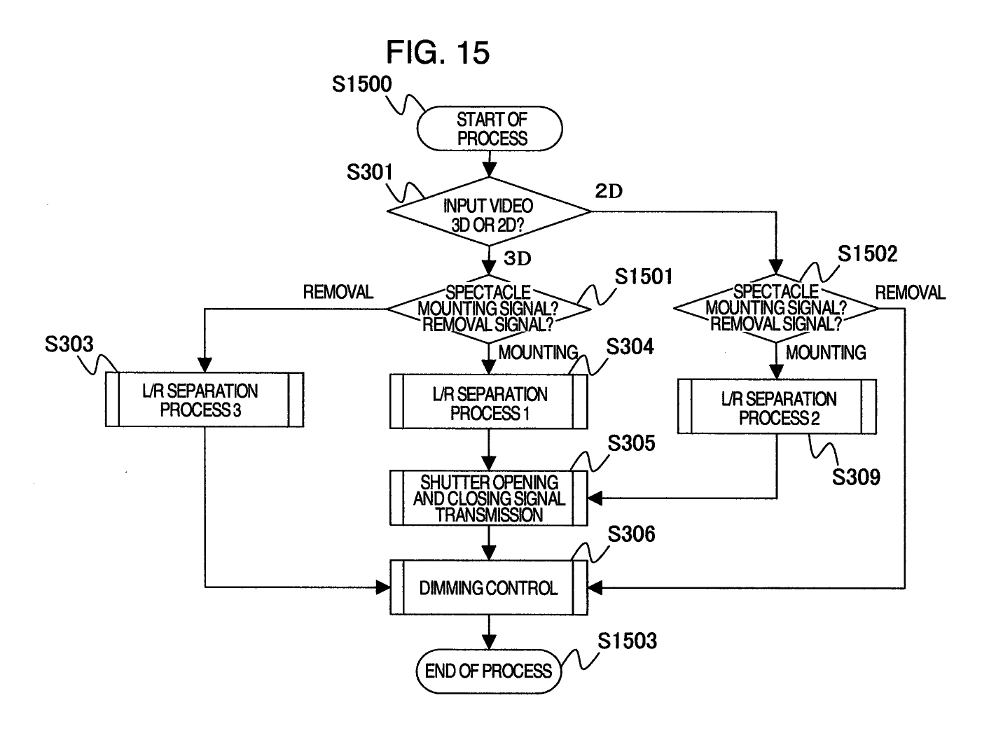

FIG. 15 is a diagram showing an example of processing of a display device of Embodiment 3.

The same sequence numbers are utilized as for the processes of Embodiment 1 described in FIG. 3. What is modified with respect to the sequence of FIG. 3 is that in the case where the input video images in Step S301 are 3D images, a spectacle mounting signal transmitted from the 3D spectacles to the remote control I/F and a spectacle removal signal are checked in Step S1501, and in the case of a removal signal, L/R separation process 3 is carried out (Step S303), processing is carried out for 2D display which can be viewed even when not wearing spectacles, and dimming control is carried out (Step S306).

In Step S1501, in case there is a spectacle mounting signal, L/R separation process 1 is carried out (Step S304) and 3D display is started. Also, in Step S301, even in case the input video images are 2D images, a spectacle mounting signal and a spectacle removal signal are checked in Step S1502. In the case of a removal signal, there is carried out dimming control for 2D display. In the case of a spectacle mounting signal, since the situation is one in which a 2D display is viewed with the spectacles on, there is carried out L/R separation process 2 (Step S309) displaying without reducing the brightness even if it is 2D, shutter opening and closing signal transmission (Step S305), and dimming control (Step S306).

In this way, in accordance with whether spectacles are worn or not, the video image brightness is chosen to be fixed, so it becomes possible to view 2D and 3D display.

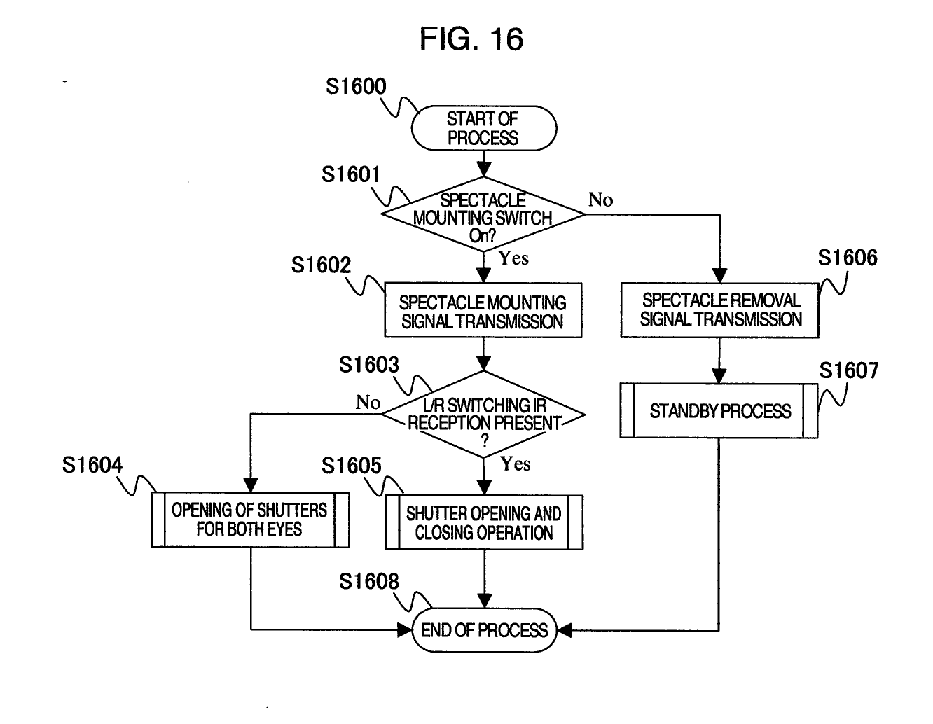

FIG. 16 is a diagram showing an example of processing of a display device of Embodiment 3.

In Step S1601, it is checked whether spectacle mounting switch 1401 is “On” or “Off” and in the case where the switch is pressed and the user has been detected to wear spectacles, there is transmitted a spectacle mounting signal with respect to remote control I/F 107 with which three-dimensional display control device 100 is equipped (Step S1602).

Subsequently, it is checked whether there can be received a signal from shutter spectacle control part 113 that can acquire L/R switching synchronization (Step S1603). In Step S1603, in case it is not possible to receive the L/R switching synchronization signal, since it is also a situation in which it is not known whether the user is watching the display device or not, it is a situation where the spectacles have been put on, so by opening the shutters of both eyes (Step S1604), the other side is made easy to watch.

In Step S1603, in case it is possible to receive the L/R switching synchronization signal, shutter opening and closing operation is started (Step S1605). In case the L/R switching synchronization signal has not been transmitted, L/R separation process 1 or 2 is operating, so 2D or 3D viewing in synchronization with the shutters is possible.

In Step S1601, in case the spectacle mounting switch is not pressed, there is emitted a spectacle removal signal with respect to remote control I/F 107 in Step S1606.

While the switch is not pressed, if transmission of a signal is continued, and since the battery of 3D spectacles 1400 does not last long, there may, because spectacle mounting is in the “On” state, be transmitted a spectacle removal signal only when there is a switch to the “Off” state.

Since it often happens that the spectacles are not utilized after transmission of the spectacle removal signal, a transition is made to an energy-conserving mode or a standby mode in which the electric power is restrained to a maximum (Step S1607). In this way, at times when the spectacles are not yet used, there is the effect of not consuming electric power.

### Fourth Embodiment

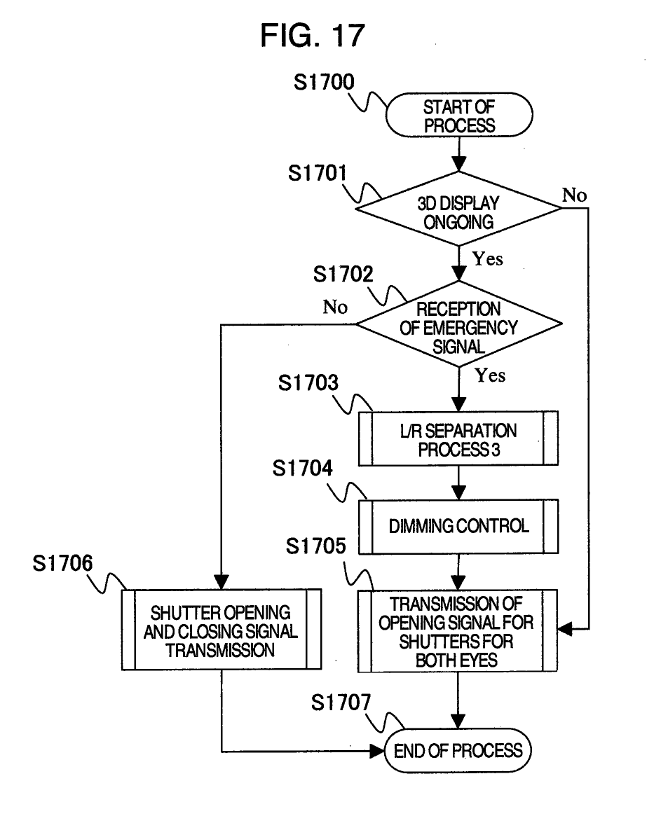

Hereinafter, Embodiment 4 will be described with reference to FIG. 17.

FIG. 17 is a diagram showing an example of processing of a display device of Embodiment 4.

In the judgment of Step S1701, in the case where 3D content which is 3D broadcast or stored in media is taken to be input, 3D spectacles are worn, and 3D display is chosen, and in case where an emergency broadcast from broadcast reception part 102 or network part 103 is signaled in Step S1702, L/R separation process 3 performing 2D display output is carried out in Step S1703, and dimming control is carried out in Step S1704. Further, in Step S1705, there is transmitted a signal to open the shutters for both eyes with respect to liquid crystal shutter spectacles. In this way, the 3D display becomes 2D display and it is possible to view the characters and video image information sent with the emergency broadcast in 2D without its getting dark.

Also, in Step S1703, it can also be considered to carry out L/R separation process 2 and to transmit a signal to open the shutters for both eyes in Step S1705. The dimming control in this case, since the dimming is A times higher than normal on the premise that spectacles are worn, since it ends up looking too bright for the user, it can be considered that there is the effect of communicating the emergency character.

According to each of the aforementioned embodiments, it is possible to reduce the difference in brightness that e.g. arises in the case where a user is performing switching between 2D and 3D display and to improve the ease of watching video images.

These embodiments, from Embodiment 1 to Embodiment 4, are described regarding a scheme in which the utilized spectacles have liquid crystal shutters, but even for a polarized spectacle scheme, similar processing is possible. Also, the programs operating on the three-dimensional display control device may be installed inside the three-dimensional display control device or the system may be devised to record the same in a recording medium and provide the same, or download the same via the network and provide the same. By not limiting these distribution modes, provision with various utilization modes becomes possible, having the effect of increasing the utilizing users.

Also, the term “3D spectacles” in the embodiments refers e.g. to spectacles compatible with a liquid crystal shutter scheme having a shutter for the right eye and a shutter for the left eye, spectacles having polarized lenses, or the like, and indicate ones that the user can put on for viewing 3D video images, which are also called “viewing devices”.

It should be further understood by those skilled in the art that although the foregoing description has been made on embodiments of the invention, the invention is not limited thereto and various changes and modifications may be made without departing from the spirit of the invention and the scope of the appended claims.

1. A display device displaying video images, comprising:
an input part into which video image information is input and
a display part displaying video image information input into said input part;
wherein,
if the displayed video images are switched from 3D video images to 2D video images, the brightness of the displayed information is modified over a prescribed period of time.

2. A display device displaying video images, comprising:
an input part into which video image information is input and
a display part displaying video image information input into said input part;
wherein,
in the case where said 3D video image information input into said input part is displayed in said display part as 2D video images, the video images for the left eye and the video images for the right eye, of said 3D video images, are separated, and the video images for the left eye, or the video images for the right eye, and black video images are displayed alternately.

3. A display device displaying video images, comprising:
an input part into which video image information is input and
a display part displaying video image information input into said input part;
wherein,
in the case where said display part is in a state of displaying 3D video images, the input 2D video image information and video image information which is the same as said 2D video image information are displayed alternately.

4. A display device displaying video images, comprising:
an input part into which video image information is input and
a display part displaying video image information input into said input part;
wherein, if said display part is modified from a state of displaying 3D video images to a state of not displaying 3D video images, the brilliance of the video images displayed by said display part is reduced.

5. The display device according to claim 4, wherein the brilliance of said video images is reduced over a prescribed period of time.

6. A display device displaying video images, comprising:
an input part into which video image information is input,
a display part displaying video image information input into said input part, and
a detection part detecting a user;
wherein said display part has a state of displaying 3D video images and a state of not displaying 3D video images and, if said detection part detects an absence of the user, said display part is modified from a state in which 3D video images are displayed into a state in which 3D video images are not displayed.

7. A display device according to claim 2, wherein,
in the case where said 3D video image information input into said input part is displayed in said display part as 2D video images, the display part displays a message inciting a modification of said display part into a state displaying 3D video images.

8. The display device according to claim 3, wherein,
in the case where said display part is in a state of displaying 3D video images,
and if 2D video image information is input into said input part,
said display part displays a message inciting a modification of said display part into a state in which 3D video images are not displayed.

9. A viewing device having a shutter for the right eye and a shutter for the left eye, and transmitting a signal indicating that the user is wearing said viewing device.

10. A display device displaying video images, comprising:
an input part into which video image information is input and
a display part displaying video image information input into said input part;
and if receiving, from the device used when the user is viewing 3D video images, a signal indicating that the user is wearing said device, switching said display part into a state in which 3D video images are displayed.

11. A display device displaying video images, comprising:
an input part into which video image information is input and
a display part displaying video image information input into said input part;
and in the case where 3D video images are displayed to said display part, switching said display part from a state in which 3D video images are displayed into a state in which 2D video images are displayed, if receiving an emergency broadcast.
